(19) United States
(12) Patent Application Publication
(10) Pub. No.: US 2022/0207537 A1
(43) Pub. Date: Jun. 30, 2022

(54) DOCUMENT PROCESSING SYSTEM WITH AUTOMATIC AFTER-SALES SERVICE AND DATA PROCESSING METHOD

(71) Applicant: AVISION INC., Hsinchu (TW)

(72) Inventor: SHIH-CHAO SHENG, Hsinchu (TW)

(21) Appl. No.: 17/553,824

(22) Filed: Dec. 17, 2021

(30) Foreign Application Priority Data
Dec. 31, 2020 (TW) 109147119

(51) Int. Cl. G06Q 30/00; H04N 1/00

(52) U.S. Cl. CPC G06Q 30/016; H04N 1/00334; H04N 1/00061; H04N 1/00344

(57) ABSTRACT

A document processing system with automatic after-sales service comprises a mobile device of a user, a remote server provided by a vendor connected to the mobile device though a network and a document processing device used to provide code information. The code information has link information and device status information of the document processing device. The user holds the mobile device to retrieve the code information, and obtains the link information and the device status information based on the code information, and sends the device status information and user contact information to the remote server. Thus, the user can quickly connect the vendor with named user contact information through network transmission technology, and the purpose of improving the convenience and efficiency of using the document processing system can be achieved.

### CROSS-REFERENCE TO RELATED APPLICATION

This non-provisional application claims priority under 35 U.S.C. § 119(a) on Patent Application No(s). 109147119 filed in Taiwan, R.O.C. on Dec. 31, 2020, the entire contents of which are hereby incorporated by reference.

### BACKGROUND OF THE INVENTION

### 1. Field of the Invention

The present disclosure relates to a document processing system, and more particularly, to a document processing system with automatic after-sales service and a data processing method thereof.

### 2. Description of the Related Art

Generally, a plurality of document processing devices is provided in companies, schools and public organizations for scanning, printing or binding documents being processed. These document processing devices can also be connected to a network, so as to transfer documents via the network.

After having been used over a period of time, the document processing devices would have the problems of damaged parts, out of consumables, etc. and require maintenance or repairing. Presently, the ways of handling the maintenance problems of these document processing devices include inspecting and repairing of the devices by vendors after receiving reports from users, reporting the problems to the vendor via a network, or periodical inspection of the devices by the vendors.

However, a user will contact with the vendor to report the problem only when a document processing device is found malfunctioned. Then, the user has to wait until the vendor's scheduled time for the required maintenance or repairing. This is obviously a trouble to the user who needs immediate help from the vendors to recover the function of the document processing device. In the case of reporting the device problem to the vendor via a network, the document processing device must be connected to a remote location, which is subjected to a certain degree of information security risk. Besides, the document processing devices in many organizations are connected to one another via a local area network or an internal network that is not connected to any other public network and accordingly, could not be used to report the device problems to the vendor. As to the periodical inspection of devices by the vendors, the intervals between the periodical inspections are relatively long and any earlier hardware update might increase unnecessary expenditure. Therefore, even if the devices are periodically inspected, there is still the possibility of unexpected situation that could not wait for next inspection to solve inefficiently. It is therefore desirable to work out an improved solution to the above problems.

### BRIEF SUMMARY OF THE INVENTION

An objective of the present disclosure is to provide a document processing system with automatic after-sales service and a data processing method thereof. The document processing system is connected to a remote location in real time using the network technology, so that information and status of the document processing system can be quickly reported to a vendor or a related manufacturer at the remote location for the latter to make corresponding judgments and take corresponding measures. Therefore, a user can use the document processing system safely in a more convenient and efficient manner.

To achieve at least the above objective, the data processing method of the document processing system with automatic after-sales service according to the present disclosure can be implemented on a mobile device and includes the following steps:

obtaining a code information;

obtaining a link information and a device status information according to the code information; and

logging in a remote location via the link information and transmitting the device status information and a user contact information to the remote location.

From the above steps, a user retrieved the code information using the mobile device can further analyze the code information to get the link information and the device status information, and then log in the remote location via the link information and transmit the device status information and a user contact information to the remote location. In this manner, information and status of the document processing system can be quickly reported via the mobile device for a vendor or related manufacturer at the remote location to quickly make corresponding judgments and take corresponding measures. Therefore, the document processing system is highly safe for use and a user can use the system in a more convenient and efficient manner.

To achieve at least the above objective, the document processing system with automatic after-sales service according to the present disclosure includes:

a remote server being connected to a network;

a document processing device including a display module and providing a code information on the display module; and the code information including a link information and a device status information; and

a mobile device being connected to the remote server via the network;

wherein, the mobile device retrieves the code information provided by the document processing device and gets the link information and the device status information according to the code information; and the mobile device logs in the remote server via the link information and transmits the device status information and a user contact information to the remote server.

With the above structure, the document processing device provides the code information that includes the link information and the device status information, so that the user can use a mobile device to retrieve the code information and get the link information and the device status information according to the code information. The mobile device can then log in the remote server via the link information and transmit the device status information the user contact information to the remote server. In this manner, related information and status of the document processing system can be quickly reported from the mobile device to the remote server, so that the vendor or related manufacturer can make corresponding judgments and take corresponding measures. Therefore, the document processing system is highly safe for use and the user can use the system in a more convenient and efficient manner.

### BRIEF DESCRIPTION OF THE DRAWINGS

FIG. 1 is a block diagram showing a document processing system according to a preferred embodiment of the present disclosure.

FIG. 2 is a block diagram showing a document processing device included in the document processing system according to the preferred embodiment of the present disclosure.

FIG. 3 is a flowchart showing the steps included in a data processing method of the document processing system according to the preferred embodiment of the present disclosure.

FIG. 4 is a flowchart showing a further step included in the data processing method of the document processing system according to the preferred embodiment of the present disclosure.

FIG. 5 is a flowchart showing further steps included in the step of obtaining code information in the data processing method of the document processing system according to the preferred embodiment of the present disclosure.

### DETAILED DESCRIPTION OF THE INVENTION

To facilitate understanding of the objects, characteristics and effects of this present disclosure, embodiments together with the attached drawings for the detailed description of the present disclosure are provided. It is noted the present disclosure can be implemented or applied in other embodiments, and many changes and modifications in the described embodiments can be carried out without departing from the spirit of the disclosure, and it is also understood that the preferred embodiments are only illustrative and not intended to limit the present disclosure in any way.

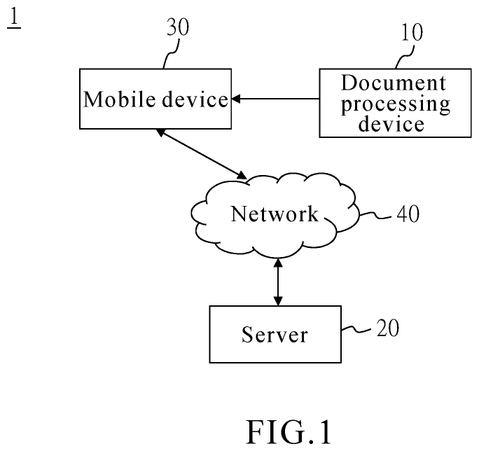

Please refer to FIG. 1. A document processing system 1 according to a preferred embodiment of the present disclosure includes a document processing device 10, a remote server 20 and a mobile device 30 of a user. The document processing device 10 and the mobile device 30 exchange information with one another, and the mobile device 30 is communicatively connected to the remote server 20 via a network 40.

The document processing device 10 provides a piece of code information, which includes a piece of link information and a piece of device status information. The mobile device 30 retrieves the code information provided by the document processing device 10 and gets the link information and the device status information from the code information. With the link information, the mobile device 30 can log in the remote server 20 via the network 40 and transmit the device status information and a piece of user contact information of the user to the remote server 20 via the network 40, so that the status of the document processing device 10 can be transmitted to the remote server 20 in real time without connecting the document processing device 10 to a public network; meanwhile, the vendor of the document processing device 10 can grasp a real-time condition of the status of the document processing device 10 from the device status information transmitted to the remote server 20 and contact the user via the user contact information to quickly provide maintaining service to the user. In this way, the document processing system 1 is more convenient and efficient for use.

In the preferred embodiment, after receiving the device status information and the user contact information, the vendor can, according to the device status information, actively provide suggestion information for the users' reference. Further, the vendor can, according to the user contact information, actively transmit a message to the mobile device 30 to provide the suggestion information for the user's reference. In this way, the user can quickly get information related to the maintaining service and quickly troubleshoot and solve the problems of the document processing device 10. Therefore, the document processing system 1 is more convenient for use.

In operable embodiments, the message can be transmitted to the mobile device 30 via the remote server 20, a telecommunication network and/or an e-mail. However, it is understood the present disclosure is not particularly limited thereto.

In the preferred embodiment, the code information can be implemented in the form of a two-dimensional barcode, such as a Quick Response (QR) code, a DataMatrix, or an Aztec code. However, it is understood the present disclosure is not particularly limited thereto.

In the preferred embodiment, the link information is a piece of webpage information, such as URL. And, the webpage information is linked with the remote server 20.

In the preferred embodiment, the device status information includes a piece of basic information, such as the model of the document processing device, the time period of use, the number of pages being processed, and a piece of error code information. However, it is understood the present disclosure is not particularly limited thereto.

In the preferred embodiment, the user contact information includes a user name, a user contact phone number and a user e-mail address. However, it is understood the present disclosure is not particularly limited thereto.

In the illustrated embodiment, the remote server 20 can be an instant messaging software server or a vendor server of the vendor. However, it is understood the present disclosure is not particularly limited thereto. The user can quickly reflect the device status information of the document processing device 10 via the instant messaging software or the vendor server, so that the document processing system 1 is more convenient and efficient for use.

In the preferred embodiment, the document processing device 10 can be implemented in the form of a scanner, a business machine, or a printer. However, it is understood the present disclosure is not particularly limited thereto.

In the preferred embodiment, the mobile device 30 can be implemented in the form of a smartphone, a tablet computer, or a handheld electronic apparatus. However, it is understood the present disclosure is not particularly limited thereto.

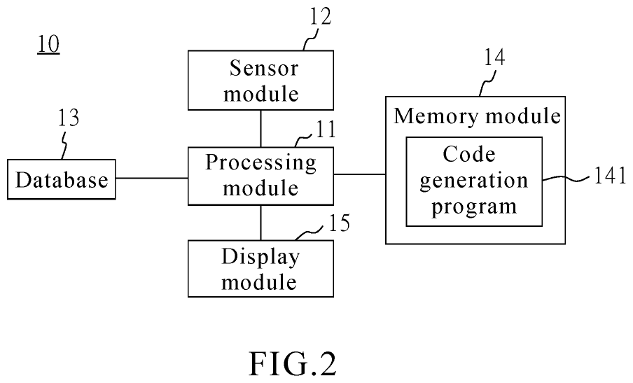

Please refer to FIG. 2, which is a block diagram showing a detailed framework of the document processing device 10. The document processing device 10 includes at least a processing module 11, at least one sensor module 12, a database 13, a memory module 14, and a display module 15. The processing module 11 is electrically connected to the at least one sensor module 12, the database 13, the memory module 14 and the display module 15.

The at least one sensor module 12 detects the status of all parts of the document processing device 10 and transmits sensing results to the processing module 11. For instance, the at least one sensor module 12 can be implemented in the form of a paper feeding sensor, a definition adjusting sensor, a temperature sensor, an out-of-paper sensor, a spacing sensor, an organic photo-conductor (OPC) drum sensor, an image scanning sensor and other sensors suitable for use with the document processing device 10. However, it is understood the present disclosure is not particularly limited thereto.

The memory module 14 stores at least one code generation program 141 for generating corresponding code information according to the link information and the device status information.

The display module 15 displays the code information. The mobile device 30 can be used to scan the code information displayed on the display module 15 to get the link information and the device status information.

The database 13 stores the link information, the basic information of the document processing device 10 and the error codes corresponding to the sensing results, and the processing module 11 can search for required information according to the sensor results.

The processing module 11 receives the sensing results and generates the device status information according to the sensing results. The processing module 11 can further read the link information stored in the database 13 and execute the code generation program 141, so that the code generation program 141 generates corresponding code information according to the link information and the device status information. The processing module 11 finally transmits the code information to the display module 15 for displaying thereon.

In an operable embodiment, the device status information includes, but not limited to, the basic information of the document processing device 10 and the sensing results or the error code information corresponding to the sensing results.

In the preferred embodiment, the processing module 11 is implemented in the form of a central processing unit (CPU).

In the preferred embodiment, the database 13 and the memory module 14 can be implemented in the form of a hard-disk drive, a memory card and/or a memory.

In the preferred embodiment, the display module 15 can be implemented in the form of a screen or a touch display.

Therefore, with the above arrangements, the document processing device 10 can generate the device status information according to the sensing results and generate the corresponding code information according to the device status information and the link information, so that the mobile device 30 can analyze and read the code information to get the device status information and the link information for reporting to the vendor. Therefore, the document processing system 1 is more convenient and efficient for use.

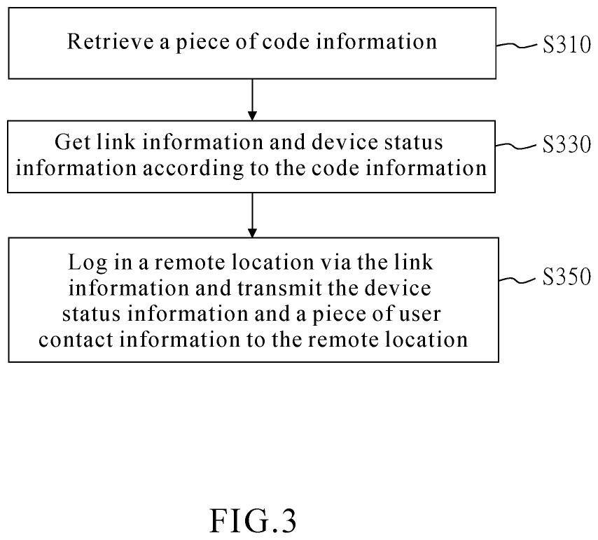

According to the above preferred embodiment of the document processing system 1 and the described content thereof, a data processing method of the document processing system is further induced. Generally, in the data processing method, a document process device 10 exchanges information with a mobile device 30, and the mobile device 30 is communicatively connected to a remote server 20 via a network 40. Please refer to FIG. 3. More specifically, the data processing method includes the following steps:

Retrieve a piece of code information (S310). In a preferred embodiment, the mobile device 30 can retrieve the code information by scanning or taking a picture of an image of the code information displayed on the document processing device 10.

Get a piece of link information and a piece of device status information according to the code information (S330). According to the preferred embodiment, the mobile device 30 can analyze the code information to get the link information and the device status information.

Log in a remote location via the link information and transmit the device status information and a piece of user contact information to the remote location (S350). In the preferred embodiment, the mobile device 30 can log in a server 20 at the remote location via the link information and transmit the device status information and the user contact information to the remote location.

In a preferred embodiment, the mobile device 30 executes the link information to log in a piece of instant messaging software and sets up a chat window with the user and the vendor of the document processing device 10 as participants thereof, and automatically transmits the device status information to the chat window. The user can also input on the mobile device 30 the user contact information and transmit the user contact information to the chat window. In this manner, the device status information of the document processing device 10 can be quickly reported to the vendor, and the vendor can immediately take corresponding measures. Therefore, the user can use the document processing system 1 in a more convenient and efficient manner.

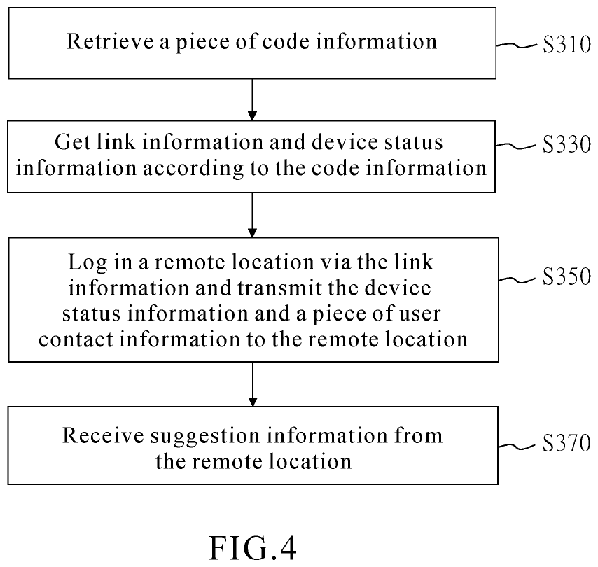

In the preferred embodiment, the method further includes the following step as shown in FIG. 4:

Receive suggestion information from the remote location (S370). The remote location can provide a piece of suggestion information according to the device status information. And further, the remote location automatically transmits a message to the mobile device 30 according to the user contact information to provide the suggestion information for the user's reference.

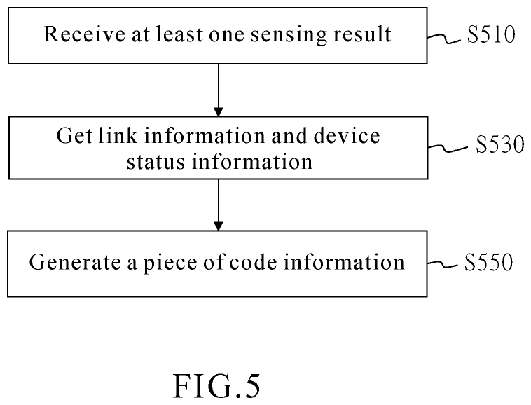

Please refer to FIG. 5. In the preferred embodiment, for the document processing device 10 to provide the code information, the method of the present disclosure further includes the following steps:

Receive at least one sensing result (S510). The document processing device 10 has a processing module 11 that receives at least one sensing result transmitted from at least one sensor module 12 of the document processing device 10.

Get a piece of link information and a piece of device status information (S530). The processing module 11 generates a piece of device status information according to the at least one sensing result and read a piece of link information stored in a database 13 of the document processing device 10.

Generate a piece of code information (S550). The processing module 11 executes a code generation program 141 that is stored in a memory module 14 of the document processing device 10, so that the code generation program 141 generates a piece of code information according to the link information and the device status information and the display module 15 of the document processing device 10 displays the code information.

In summary, in the present disclosure, the document processing device 10 displays the code information that includes the link information and the device status information, and the user can use his/her mobile device 30 to retrieve the code information and analyze the same to obtain the link information and the device status information. Further, the mobile device 30 can use the link information to communicatively connect to a remote server 20 via a network 40 and transmit the device status information of the document processing device 10 and the user's user contact information to the remote server 20 in real time. With these arrangements, the vendor can still receive the device status information of the document processing device 10 in real time even if the document processing device 10 is not connected to a public network, and can quickly make an accurate judgment according to the device status information about the measures that are required by the document processing device 10. Meanwhile, the vendor also contacts with the user in real time using the user contact information provided by the user. Therefore, the document processing system 1 of the present disclosure is highly safe for use and the user can use the system 1 in a more convenient and efficient manner.

While the present disclosure has been described by means of a specific embodiment, numerous modifications and variations could be made thereto by persons skilled in the art without departing from the scope and spirit of the present disclosure set forth in the claims.

What is claimed is:

1. A data processing method of a document processing system with automatic after-sales service, the method comprising the following steps for implementing on a mobile device:
obtaining a code information;
obtaining a link information and a device status information according to the code information; and
logging in a remote location via the link information and transmitting the device status information and a user contact information to the remote location.

2. The data processing method according to claim 1, wherein the step of obtaining a link information and a device status information according to the code information further includes the step of analyzing the code information to get the link information and the device status information.

3. The data processing method according to claim 1, wherein the step of logging in a remote location via the link information and transmitting the device status information and a user contact information to the remote location further includes a step of logging in an instant messaging software via the link information and transmitting the device status information and the use contact information to the instant messaging software.

4. The data processing method according to claim 1, further comprising the step of receiving suggestion information from the remote location.

5. The data processing method according to claim 1, further comprising the following steps for implementing on a document processing device:
receiving at least one sensing result;
obtaining the link information and the device status information; and
generating and displaying the code information.

6. The data processing method according to claim 1, wherein the code information includes a quick response code (QR code); the link information includes a webpage information; and the device status information includes basic information of a document processing device and an error code information.

7. The data processing method according to claim 1, wherein the user contact information includes a user name, a user contact phone number and an email address.

8. The data processing method according to claim 1, wherein the remote location includes an instant messaging software server and a vendor server.

9. A document processing system with automatic after-sales service, comprising:
a remote server being connected to a network;
a document processing device including a display module and providing a code information on the display module; and the code information including a link information and a device status information; and
a mobile device being connected to the remote server via the network;
wherein, the mobile device retrieves the code information provided by the document processing device and gets the link information and the device status information according to the code information; and the mobile device logs in the remote server via the link information and transmits the device status information and a user contact information to the remote server.

10. The document processing system according to claim 9, wherein the remote server includes an instant messaging software server and a vendor server.

11. The document processing system according to claim 9, wherein the code information includes a two-dimensional barcode.

12. The document processing system according to claim 9, wherein the link information includes a webpage information.

13. The document processing system according to claim 9, wherein the device status information includes basic information of the document processing device and an error code information.

14. The document processing system according to claim 9, wherein the user contact information includes a user name, a user contact phone number and an email address.

15. The document processing system according to claim 9, wherein the document processing device includes a scanner, a business machine and a printer.

16. The document processing system according to claim 9, wherein the mobile device includes a smartphone, a tablet computer and a handheld electronic apparatus.

17. The document processing system according to claim 9, wherein the display module includes a screen and a touch display.
